(19) United States
(12) Patent Application Publication
(10) Pub. No.: US 2023/0150457 A1
(43) Pub. Date: May 18, 2023

(54) MOP MITT FOR CAR WASHING, MOP BODY FOR CAR WASHING, AND METHOD OF MANUFACTURING MOP MITT FOR CAR WASHING

(71) Applicant: A-TOP Co., Ltd., Siheung-si (KR)

(72) Inventor: Yong Cheol HONG, Siheung-si (KR)

(73) Assignee: A-TOP Co., Ltd., Siheung-si (KR)

(21) Appl. No.: 17/538,626

(22) Filed: Nov. 30, 2021

(30) Foreign Application Priority Data
Nov. 15, 2021 (KR) 10-2021-0156283

(51) Int. Cl. B60S 3/04; A46B 5/00; A46B 5/02

(52) U.S. Cl. CPC B60S 3/045; A46B 5/0012; A46B 5/02

(57) ABSTRACT

Disclosed herein are a mop mitt for car washing, a mop body for car washing, and a method of manufacturing a mop mitt for car washing. According to one embodiment of the present invention, there is provided a mop mitt for car washing, the mop mitt including: a first surface sewn in the state in which an outer peripheral portion has been folded inward, and forming one surface of a pocket shape having one open side; and a second surface extending from the first surface, rotated around a central portion, and facing the first surface; wherein the first and second surfaces are sewn together on both sides of thereof, so that the mop mitt for car washing is gripped through an insertion portion having one open side.

### CROSS-REFERENCE TO RELATED APPLICATION

This application claims the benefit of Korean Patent Application No. 10-2021-0156283 filed on Nov. 15, 2021, which is hereby incorporated by reference herein in its entirety.

### BACKGROUND

### 1. Technical Field

The present invention relates to a mop mitt for car washing, a mop body for car washing, and a method of manufacturing a mop mitt for car washing.

### 2. Description of the Related Art

In general, car washing methods may be classified into two types of car washing methods: manual car washing methods that are directly performed by a user or the like, and automatic car washing methods that are performed by a machine. The automatic car washing methods are divided into a tunnel-type automatic car washing method and a door-type automatic car washing method.

Meanwhile, when water is removed from a car after the car has been washed using one of the manual car washing methods, the water remaining on the car is wiped away using a towel or a mop for car washing.

For this purpose, in Korean Utility Model Registration No. 20-0238713, adhesive tapes are attached to multiple portions of the front and back surfaces of a glove and non-woven fabrics for face washing and surface washing are detachably attached, and non-woven fabrics each having a waterproof coating layer are superimposed in a plurality of layers on one of the front and back surfaces of the glove and include sewing seams each for attaching a nonwoven fabric so that they are easy to peel off one by one after use.

However, the prior art mop for car washing is disadvantageous in that it is inconvenient to use, in that car washing takes a long time because a contact area between the mop and a car is narrow due to the glove shape of the mop and thus car washing is not performed effectively, and in that the convenience of use and a cleaning effect during car washing are not desirable. Therefore, there is an increasing need for equipment capable of efficiently washing a car.

### SUMMARY

The present invention has been conceived to overcome the problems of the prior art, and an object of the present invention is to provide a mop mitt for car washing, a mop body for car washing, and a method of manufacturing a mop mitt for car washing that can reduce a cleaning effort by increasing a contact area between the mop mitt for car washing and a car and can also improve washing efficiency by reducing cleaning time.

According to an aspect of the present invention, there is provided a mop mitt for car washing, the mop mitt including: a first surface sewn in the state in which an outer peripheral portion has been folded inward, and forming one surface of a pocket shape having one open side; and a second surface extending from the first surface, rotated around a central portion, and facing the first surface; wherein the first and second surfaces are sewn together on both sides of thereof, so that the mop mitt for car washing is gripped through an insertion portion having one open side.

The middle portion of the mop mitt for car washing may be sewn to partition the inner space of the mop mitt for car washing.

A drain hole may be formed in a part of the mop mitt for car washing.

According to another aspect of the present invention, there is provided a mop body for car washing, the mop body including: a spreading plate configured to be inserted into an insertion portion having one open side and formed in a mop mitt for car washing, and to spread the mop mitt for car washing; and a handle rod coupled with the spreading plate, and configured to allow the mop mitt for car washing to wipe the surface of a car in such a manner that an operator grips and pushes/pulls the handle rod with his or her hand; wherein the spreading plate includes: a support portion configured to be inserted into an inner side of the insertion portion, and to support the mop mitt for car washing; and a bendable portion configured to be bendable because it has lower rigidity than the support portion.

The support portion and the bendable portion may be injection-molded using the same resin material in an integrated form.

The bendable portion may have smaller thickness than the support portion.

Flexible holes or flexible slits may be formed in the bendable portion so that the bendable portion can be bent by causing the rigidity of the bendable portion to be lower than that of the support portion.

The handle rod may be detachably coupled to the spreading plate, so that handle rods having different lengths can be coupled to the spreading plate.

Molded Velcro tapes may be provided on and screwed to both sides of one end of the spreading plate, so that the spreading plate can be fastened to the mop mitt for car washing by the molded Velcro tapes.

According to still another aspect of the present invention, there is provided a method of manufacturing a mop mitt for car washing, the method including: folding the outer peripheral portion of a mop mitt for car washing inward, and sewing the outer peripheral portion; folding the mop mitt for car washing around a central portion so that first and second surfaces in which the outer peripheral portion has been sewn face each other; sewing both side portions of the facing first and second surfaces to form a pocket-shaped inner space; and sewing the middle portion of the mop mitt for car washing to partition the pocket-shaped inner space.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a perspective view showing a mop mitt for car washing according to one embodiment of the present invention;

FIG. 2 is a schematic view showing a state in which the outer peripheral portion of the mop mitt for car washing according to the embodiment of the present invention shown in FIG. 1 is folded;

FIG. 3 is a schematic view showing a state in which both side portions and middle portion of the mop mitt for car washing according to the embodiment of the present invention are sewn;

FIG. 4 is a schematic plan view showing a mop body for car washing according to another embodiment of the present invention;

FIG. 5 is a schematic side view showing the mop body for car washing according to the other embodiment of the present invention;

FIG. 6 is a schematic view showing the use of the mop body for car washing according to the other embodiment of the present invention; and

FIG. 7 is a flowchart showing a method of manufacturing a mop mitt for car washing according to another embodiment of the present invention.

### DETAILED DESCRIPTION

The embodiments to be described below are provided such that an operator can easily understand the technical spirit of the present invention, and the present invention is not limited thereto. Furthermore, the items shown in the accompanying drawings are schematically illustrated to facilitate the description of the embodiments of the present invention, and may be different from the actual forms implemented in practice.

When a component is described as being connected or coupled to another component, it should be understood that they may be directly connected or coupled to each other, but a third component may be present therebetween.

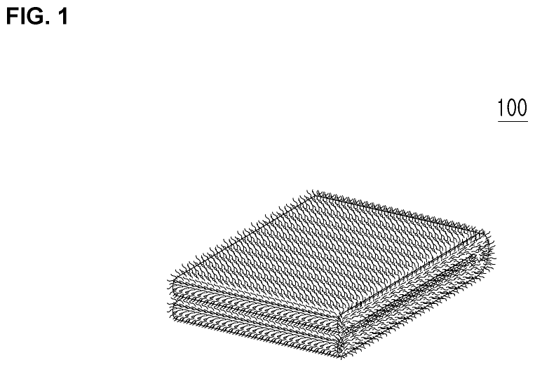

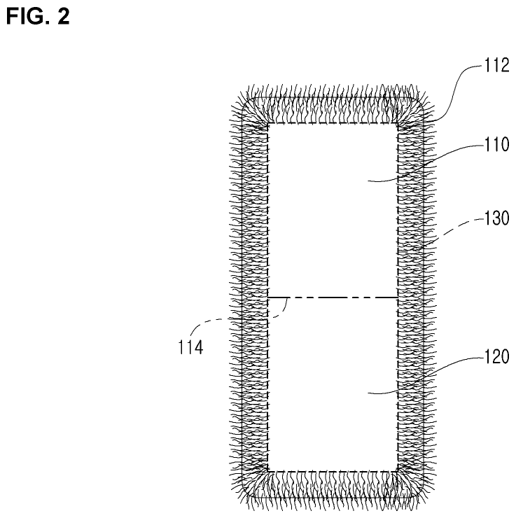

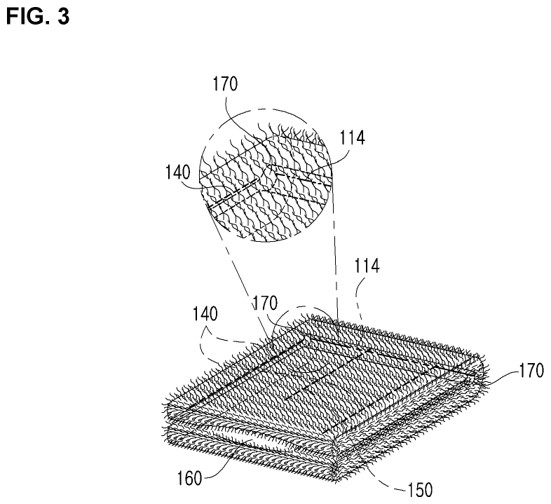

FIG. 1 is a perspective view showing a mop mitt for car washing according to one embodiment of the present invention, FIG. 2 is a schematic view showing a state in which the outer peripheral portion of the mop mitt for car washing according to the embodiment of the present invention shown in FIG. 1 is folded, and FIG. 3 is a schematic view showing a state in which both side portions and middle portion of the mop mitt for car washing according to the embodiment of the present invention are sewn.

Referring to FIGS. 1 to 3 together, a mop mitt 100 for car washing according to an embodiment of the present invention includes: a first surface 110 sewn in the state in which the outer peripheral portion 112 thereof has been folded inward, and forming one surface of a pocket shape having one open side; and a second surface 120 extending from the first surface 110, rotated around a central portion 114, and facing the first surface 110. The first and second surfaces 110 and 120 are sewn together by sewing second sewing portions 140 located on both sides of thereof, so that the mop mitt 100 for car washing is gripped through an insertion portion 160 having one open side.

The outer peripheral portion 112 of the mop mitt 100 for car washing according to the present invention refers to a size space between each end of the mop mitt 100 for car washing and a corresponding one of the first sewing portions 130 in the state in which the ends of the mop mitt 100 for car washing have been folded inward.

The fabric of the mop mitt 100 for car washing according to the present invention is configured to include threads having different thicknesses and lengths, i.e., first and second yarns. The outer peripheral portion 112 is folded to the inside of the mop mitt 100 for car washing and is sewn in the first sewing portion 130 so that the first and second yarns are directed outward. Accordingly, the first and second yarns are also directed in lateral directions to increase the contact area between the mop mitt 100 for car washing and a car, so that liquid or contaminants can be easily wiped away.

A yarn that is usable as the first yarn is not particularly limited, but is preferably at least one selected from the group consisting of a polyester yarn, a copolyester yarn, a polyamide yarn, and a polyethylene yarn. It is also preferable to use a polyester/polyamide synthetic yarn, polyethylene/polyamide synthetic yarn or polyester/copolyester synthetic yarn, or a polyester single yarn, polyamide single yarn or polyethylene single yarn.

In addition, a yarn that is usable as the second yarn is not particularly limited as long as it is known in the art, but is preferably at least one selected from the group consisting of a polyester yarn, a polyamide yarn, and a polyethylene yarn.

In one specific example, the third sewing portion 150 located in the middle portion of the mop mitt 100 for car washing is sewn such that an inner space is partitioned. In other words, the second sewing portions 140 located on both sides of mop mitt 100 for car washing are sewn together in the state in which the first and second surfaces 110 and 120 are superimposed on each other, and form a pocket forming the inner space.

The second sewing portions 140 located on both sides of the mop mitt 100 for car washing are both sides of the mop mitt 100 for car washing parallel to the central portion 114 folded around the center thereof and a direction opposite to the central portion 114.

In addition, a third sewing portion 150 located in the middle portion is sewn to partition the inner accommodation space formed by the first and second surfaces 110 and 120 across which the second sewing portions 140 are sewn. In this case, it is preferable that the third sewing portion 150 be sewn along a direction parallel to the directions in which both the second sewing portions 140 are sewn.

Furthermore, in one specific example, a drain hole 170 may be formed in a part of the mop mitt 100 for car washing.

Both the second sewing portions 140 are sewn in the state of being spaced apart from ends of the central portion 114, so that the drain hole 170 can be formed between both the second sewing portions 140 and the central portion 114. Alternatively, the drain hole 170 may be formed by perforating a part of the mop mitt 100 for car washing.

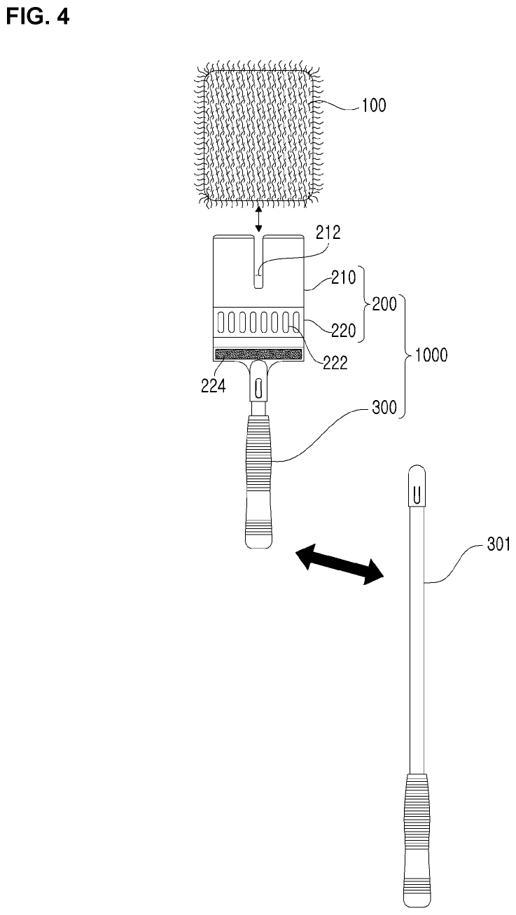

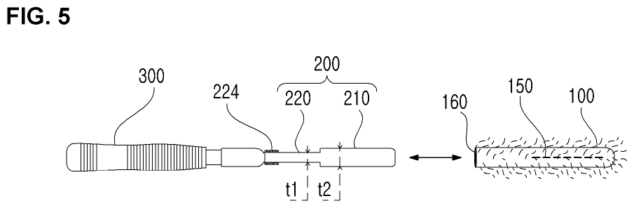

FIG. 4 is a schematic plan view showing a mop body for car washing according to another embodiment of the present invention, and FIG. 5 is a schematic side view showing the mop body for car washing according to the other embodiment of the present invention.

The mop body 1000 for car washing according to the other embodiment of the present invention includes: a spreading plate 200 configured to be at least partially inserted into the insertion portion 160 having one open side between the first and second surfaces 110 and 120 of the mop mitt 100 for car washing, and to spread the mop mitt 100 for car washing; and a handle rod 300 coupled with the spreading plate 200, and configured to allow the mop mitt 100 for car washing to wipe the surface of a car in such a manner that an operator grips and pushes/pulls the handle rod 300 with his or her hand. The spreading plate 200 includes: a support portion 210 configured to be inserted into the innermost part of the insertion portion 160 and to support the mop mitt 100 for car washing; and a bendable portion 220 configured to be bendable because it has lower rigidity than the support portion 210.

It is preferable that in the mop body 1000 for car washing according to the other embodiment of the present invention, the support portion 210 and the bendable portion 220 be injection-molded using the same resin material in an integrated form.

In this case, injection molding is a manufacturing process for producing various parts by injecting molten materials into molds. An injection molding machine includes various components: a hopper configured such that chips are put thereinto, a heating vessel configured to heat and melt a raw material, a screw configured to push out the melted plastic, and a mold configured to mold the raw material into a desired shape.

First, the chips are weighed in a predetermined amount in the hopper, and are then transferred to the heating vessel. Then, they are melted while being pushed by the screw, and the molten plastic is then injected into the mold from an injection nozzle. As the mold has been cooled, the injected plastic solidifies immediately, and a molded product is automatically ejected from the mold.

Plastics are divided into thermoplastic plastics and thermosetting plastics. Thermoplastic plastics are polymers that melt when they are heated and return to a solid state when the temperature is sufficiently lowered. Many thermoplastic plastics are produced by polymer compounds that interact with weak intermolecular forces. Unlike thermosetting plastics, thermoplastic plastics melt when heated and return to their original state, so that they have the property of being recyclable. These include polyethylene, polyethylene terephthalate, polyvinyl chloride, polyvinylidene chloride, polystyrene, polypropylene, and the like.

In contrast, thermosetting plastics are plastics that do not melt and burn to form powder or generate gas when heat is applied, and do not melt again once hardened, unlike thermoplastic plastics. These include epoxy resins, amino resins, phenol resins, polyester resins, and the like.

It is obvious that in addition to the manufacturing method using such a plastic material, there may be possible a method in which the support portion 210 and the bendable portion 220 include rubber, a spring, or the like, so that the bendable portion 220 is bent with respect to the support portion 210.

In one specific example, the bendable portion 220 is preferably thinner than the support portion 210. In other words, the thickness t1 of the bendable portion 220 is preferably smaller than the thickness t2 of the support portion 210.

Furthermore, flexible holes 222 or flexible slits are formed in the bendable portion 220 so that the rigidity of the bendable portion 220 is lower than that of the support portion 210, and thus the bendable portion 220 can be bent. It is preferable that the flexible holes 222 have a shape having a length longer than a width in the longitudinal direction of the spreading plate 200 and a plurality of flexible holes 222 be formed to be spaced apart from each other.

In this structure, the handle rod 300 is detachably coupled to the spreading plate 200, so that a handle rod 301 having a different length, i.e., a longer length than the short handle rod 300, can be coupled to the spreading plate 200. In addition to this feature, the handle rods 300 and 301 may be rotated toward the spreading plate 200 to facilitate storage, or the long handle rod 301 may be extended.

According to the present invention, injection Velcro strips 224 are provided on and screwed to both sides of one end of the spreading plate 200. In other words, the injection Velcro strips 224 are located on both sides of one end of the spreading plate 200, and screws are fastened through the injection Velcro strips 224 and the spreading plate 200. Accordingly, the connecting portions of the spreading plate 200 and the handle rod 300 are firmly coupled to each other, and the injection Velcro strips 224 come into close contact the mop mitt 100 for car washing when they are coupled to each other.

Furthermore, the third sewing portion 150 formed in the middle portion of the inner side of the insertion portion 160 is located in the cutout slot 212 of the spreading plate 200. In this case, the third sewing portion 150 is a portion formed by sewing both inner sides of the mop mitt 100 for car washing. In addition, the cutout slot 212 is formed in the central portion of the support portion 210, so that the support portion 210 may be bent around the cutout slot 212.

Accordingly, when an operator washes a car using the mop body 1000 or a hand, the mop mitt 100 for car washing is brought into close contact with the mop body 1000 or both sides of the hand by the third sewing portion 150 formed in the middle portion of the inner side of the insertion portion 160.

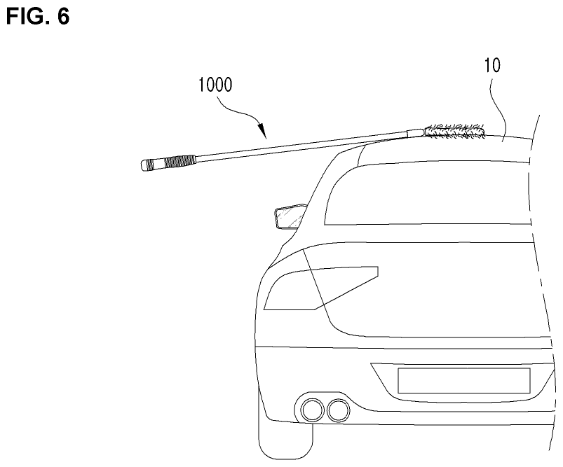

FIG. 6 is a schematic view showing the use of the mop body for car washing according to the other embodiment of the present invention.

Referring to FIG. 6 together with FIGS. 1 to 5, the operating relationship between the mop mitt 100 for car washing and the mop body 1000 for car washing according to the present invention will be described. First, the outer peripheral portion 112 of the mop mitt 100 for car washing is folded inward and then sewn.

The insertion portion 160 having one open side is formed by folding the mop mitt 100 for car washing around the central portion 114 and then sewing the second sewing portions 140 on both sides of the first and second surfaces 110 and 120.

In this case, the drain hole 170 is formed between the second sewing portions 140 and the central portion 114 by sewing the second sewing portions 140 in the state of being spaced apart from ends of the central portion 114.

Then, the third sewing portion 150 in the middle portion of the pocket-shaped inner space of the mop mitt 100 for car washing is sewn to partition the pocket-shaped inner space.

In the case where the mop body 1000 for car washing is used, the mop body 1000 for car washing is inserted into the insertion portion 160 that is open in one side of the mop mitt 100 for car washing.

An operator wipes the surface of the car 10 while holding the mop body 1000 for car washing, inserted into the mop mitt 100 for car washing, with a hand and pushing or pulling it.

In this case, the spreading plate 200 is configured to include the support portion 210 configured to support the mop mitt 100 for car washing and the bendable portion 220 configured to be bendable because it has lower rigidity than the support portion 210. In the upper portion of the car 10, i.e., in a portion that is difficult for a hand to reach, the bendable portion 220 is bent, so that the support portion 210 comes into close contact with the car 10. Also, even when the lower part of the vehicle 10 is washed, the bendable portion 220 is bent along the exterior of the vehicle 10, so that the support portion 210 comes into contact with the vehicle 10. As described above, when the bendable portion 220 is bent with respect to the support portion 210, the area where the mop mitt 100 for car washing comes into contact with the car 10 increases, thereby increasing the area of the vehicle 10 that can be wiped.

Accordingly, in the case where the mop mitt for car washing according to the present invention is gripped with a hand and then used, the mop mitt for car washing may be conveniently used, with the insertion portion 160 in which the pocket-shaped inner space is partitioned being gripped.

Furthermore, when the mop mitt for car washing and the mop body for car washing according to the present invention are combined with each other and then used, a washing effect can be improved by increasing a contact area between the mop mitt for car washing and a car, and there is provided the effect of easily washing all parts of a car that are difficult for a hand to reach.

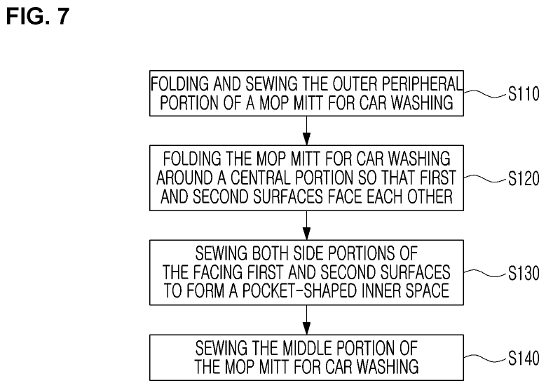

FIG. 7 is a flowchart showing a method of manufacturing a mop mitt for car washing according to another embodiment of the present invention.

Referring to FIG. 7 together with FIGS. 1 to 6, the method of manufacturing a mop mitt for car washing according to the present embodiment will now be described. First, the outer peripheral portion 112 of the mop mitt 100 for car washing is folded inward and then sewn at step S110.

The mop mitt 100 for car washing in which the outer peripheral portion 112 has been folded as described above is folded around the central portion 114 so that the first and second surfaces 110 and 120 in which the outer peripheral portion 112 has been sewn face each other at step S120.

The insertion portion 160 having one open side is formed to make a pocket shape by sewing the second sewing portions 140 on both sides of the first and second surfaces 110 and 120 made to face each other through the folding around the central portion 114 at step S130.

In this case, the drain hole 170 may be formed between the second sewing portions 140 and the central portion 114 by sewing the second sewing portions 140 in the state of being spaced apart from ends of the central portion 114.

Then, the third sewing portion 150 in the middle portion of the pocket-shaped inner space of the mop mitt 100 for car washing is sewn to partition the pocket-shaped inner space at step S140.

Accordingly, when the pocket-shaped inner space is partitioned and a hand or the mop body for car washing is inserted and grips the mop mitt for car washing through the insertion portion, the mop mitt for car washing may be prevented from being shaken or separated and be conveniently used.

Accordingly, the mop mitt for car washing according to the present invention may provide the effect of facilitating the use of the mop mitt for car washing by allowing a hand or the mop body for car washing to be inserted into the pocket-shaped inner space, and may also provide the effect of shortening washing time by increasing a contact area between the mop mitt for car washing and a car.

Furthermore, the mop mitt for car washing according to the present invention is convenient to use, and can wash a car within a short period of time, thereby improving the efficiency of car washing.

The mop mitt for car washing according to the present invention has the following effects:

First, the mop mitt for car washing is convenient to use because it has a pocket-shaped inner space and is thus easy to grip.

Second, the mop mitt for car washing may conveniently perform car washing because the mop mitt for car washing can be used by hand and can be used in combination with the mop body for car washing.

Third, car washing time may be shortened by increasing a contact area between the mop mitt for car washing and a car.

Fourth, all parts of a car that cannot be reached by a hand may be easily washed.

Fifth, the efficiency of car washing may be improved because a car can be washed within a short period of time.

Sixth, a car may be conveniently washed in comfortable positions without difficult actions.

Those of ordinary skill in the art to which the present invention pertains will understand that the present invention may be embodied in other specific forms without changing the technical spirit or essential features of the present invention. Therefore, the embodiments described above are merely exemplary embodiments selected from among various possible embodiments and presented in order to help an operator understand the present invention, and the technical spirit of the present invention is not necessarily restricted or limited only to the presented embodiments. It is obvious that various changes, additions, and modifications, as well as other equivalent embodiments, may be possible within the scope of the present invention without departing from the spirit of the present invention.

What is claimed is:

1. A mop mitt for car washing, the mop mitt comprising:
a first surface sewn in a state in which an outer peripheral portion has been folded inward, and forming one surface of a pocket shape having one open side; and
a second surface extending from the first surface, rotated around a central portion, and facing the first surface;
wherein the first and second surfaces are sewn together on both sides of thereof, so that the mop mitt for car washing is gripped through an insertion portion having one open side.

2. The mop mitt of claim 1, wherein a middle portion of the mop mitt for car washing is sewn to partition an inner space of the mop mitt for car washing.

3. The mop mitt of claim 1, wherein a drain hole is formed in a part of the mop mitt for car washing.

4. A mop body for car washing, the mop body comprising:
a spreading plate configured to be inserted into an insertion portion having one open side and formed in a mop mitt for car washing, and to spread the mop mitt for car washing; and
a handle rod coupled with the spreading plate, and configured to allow the mop mitt for car washing to wipe a surface of a car in such a manner that an operator grips and pushes/pulls the handle rod with his or her hand;
wherein the spreading plate comprises:
a support portion configured to be inserted into an inner side of the insertion portion, and to support the mop mitt for car washing; and
a bendable portion configured to be bendable because it has lower rigidity than the support portion.

5. The mop body of claim 4, wherein the support portion and the bendable portion are injection-molded using a same resin material in an integrated form.

6. The mop body of claim 4, wherein the bendable portion has smaller thickness than the support portion.

7. The mop body of claim 4, wherein flexible holes or flexible slits are formed in the bendable portion so that the bendable portion can be bent by causing rigidity of the bendable portion to be lower than that of the support portion.

8. The mop body of claim 4, wherein the handle rod is detachably coupled to the spreading plate, so that handle rods having different lengths can be coupled to the spreading plate.

9. The mop body of claim 4, wherein molded Velcro tapes are provided on and screwed to both sides of one end of the spreading plate, so that the spreading plate can be fastened to the mop mitt for car washing by the molded Velcro tapes.

10. A method of manufacturing a mop mitt for car washing, the method comprising:
folding an outer peripheral portion of a mop mitt for car washing inward, and sewing the outer peripheral portion;
folding the mop mitt for car washing around a central portion so that first and second surfaces in which the outer peripheral portion has been sewn face each other;
sewing both side portions of the facing first and second surfaces to form a pocket-shaped inner space; and
sewing a middle portion of the mop mitt for car washing to partition the pocket-shaped inner space.
